(19) United States
(12) Patent Application Publication
(10) Pub. No.: US 2022/0128383 A1
(43) Pub. Date: Apr. 28, 2022

(54) OTDR measurement via wavelength/frequency sweeping in phase-sensitive DAS/DVS systems

(71) Applicant: NEC Laboratories America, Inc., Princeton, NJ (US)

(72) Inventors: Yue-Kai Huang, Princeton, NJ (US); Ezra lp, West Windsor, NJ (US)

(73) Assignee: NEC LABORATORIES AMERICA, INC, Princeton, NJ (US)

(21) Appl. No.: 17/496,678

(22) Filed: Oct. 7, 2021

Related U.S. Application Data
(60) Provisional application No. 63/089,094, filed on Oct. 8, 2020.
(60) Provisional application No. 63/093,323, filed on Oct. 19, 2020.

(51) Int. Cl. G01D 5/353

(52) U.S. Cl. CPC G01D 5/35361

(57) ABSTRACT

Aspects of the present disclosure describe DAS/DVS DFOS systems, methods, and structures that advantageously enable/provide OTDR measurement(s).

### CROSS REFERENCE

This disclosure claims the benefit of U.S. Provisional Patent Application Ser. No. 63/089,094 filed 8 Oct. 2020, the entire contents of which is incorporated by reference as if set forth at length herein.

### TECHNICAL FIELD

This disclosure relates generally to fiber optic telecommunications networks and distributed fiber optic sensing (DFOS) systems, methods, and structures. More specifically, it pertains to optical time-domain reflectometry (OTDR) measurements made using wavelength/frequency sweeping in phase-sensitive distributed acoustic sensing (DAS)/distributed vibration sensing (DVS) systems.

### BACKGROUND

Recently, distributed fiber optic sensing (DFOS) systems, methods, and structures have found widespread use in numerous applications including infrastructure monitoring, intrusion detection, and seismic monitoring, due—in part—to its numerous advantages over traditional sensor systems and methods.

Two DFOS techniques, namely distributed acoustic sensing (DAS) and distributed vibration sensing (DVS), employ backward Rayleigh scattering effects to detect changes in fiber strain, while the fiber itself acts as a transmission medium for conveying optical sensing signal(s) back to an interrogator. As DAS/DVS technologies continue to be employed in fiber optic networks for sensing, it is anticipated that they can provide valuable fiber loss information to traditional network operations if OTDR functions can be implemented therein.

### SUMMARY

An advance in the art is made according to aspects of the present disclosure directed to DAS/DVS DFOS systems, methods, and structures that advantageously enable/provide OTDR measurement(s).

In sharp contrast to the prior art, systems, methods, and structures according to aspects of the present disclosure permit such OTDR measurements even with high coherence lasers used in DAS/DVS. By sweeping the wavelength or frequency of the laser, multiple measurements are made of distributive Rayleigh scatterings that exhibit different amplitude fluctuations. As each measurement provides uncorrelated fringe profiles from the Rayleigh interferometric process, measured traces may be averaged across swept wavelengths/frequencies to remove any amplitude fluctuations and obtain an underlying distributive fiber loss. Of further advantage, such wavelengths/frequencies sweeping may be performed either internally by the laser or by applying modulation signals externally.

Viewed from a first aspect, our inventive approach(es) employ laser wavelength/frequency scanning to achieve OTDR measurements of distributive fiber losses. In prior-art DAS/DVS systems, measuring distributive Rayleigh scattering using single wavelength/frequency(ies) alone produce high amplitude fluctuations resulting from the use of a high coherence laser for the Rayleigh interferometry. In sharp contrast, and according to an aspect of the present disclosure, by performing wavelength/frequency scanning and averaging across different measurements, systems, methods, and structures according to the present disclosure advantageously remove the amplitude fluctuations and reveal underlying fiber loss profile(s). Importantly, our trace averaging technique is fundamentally different than that of a traditional OTDR, in which any averaging was needed to reduce system noise in long-range or fine resolution settings.

Viewed from another aspect, our inventive approach(es) disclosed herein detail methods that advantageously achieve laser wavelength/frequency scanning suitable for OTDR measurements in DAS/DVS systems. While a scanning range of 10-GHz (80 pm) or more are needed to achieve sufficient suppression of Rayleigh amplitude fluctuations, our inventive techniques disclosed herein achieve laser wavelength scanning by changing a temperature of the laser cavity (thermal tuning) or a length of the cavity using piezo-electric effect (piezoelectric tuning) or combinations thereof. Additionally, our inventive techniques disclosed herein demonstrate that external optical frequency scanning can also/alternatively be employed using an RF frequency source and a single-sideband optical modulator, for example, IQ modulators to push-pull Mach-Zehnder modulators (MZMs).

### BRIEF DESCRIPTION OF THE DRAWING

A more complete understanding of the present disclosure may be realized by reference to the accompanying drawing in which:

FIG. 1 is a schematic diagram of illustrative coherent DAS configuration with laser wavelength scanning for OTDR measurements according to aspects of the present disclosure;

FIG. 2 is a plot of a power profile of a Rayleigh signal in a DAS operation without wavelength frequency scanning;

FIG. 3(A), FIG. 3(B), and FIG. 3(C) are plots illustrating power profiles measured with DAS using thermal wavelength tuning in which: FIG. 3(A) shows 50 pm range tuning; FIG. 3(B) shows 100 pm range tuning; and FIG. 3(C) shows 500 pm range tuning, according to aspects of the present disclosure; and

FIG. 4(A) and FIG. 4(B) are plots illustrating power profiles measured with DAS using piezo-electric wavelength tuning in which: FIG. 4(A) shows a first 2×25-km fiber spool; and FIG. 4(B) shows a second 2×25 km fiber spool, according to aspects of the present disclosure.

### DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

By way of some additional background—we again note that in recent years, distributed fiber optic sensing (DFOS) systems including distributed vibration sensing (DVS) and distributed acoustic sensing (DAS) have found widespread acceptance in numerous applications including—but not limited to—infrastructure monitoring, intrusion detection, and earthquake detection. For DAS and DVS, backward Rayleigh scattering effects are used to detect changes in the fiber strain, while the fiber itself acts as the transmission medium for conveying the optical sensing signal back to an interrogator for subsequent analysis. Those skilled in the art will understand and appreciate that the DAS/DVS measurement technique is like an optical time-domain reflectometry (OTDR) arrangement, used to measure distributive fiber loss in fiber-optic networks. Due to such similarity, DAS and DVS are also referred as “phase-sensitive” OTDR.

As DAS/DVS technologies become deployed in fiber-optic networks for sensing applications, they advantageously can provide valuable fiber loss information to traditional network operation if an OTDR function can also be implemented.

In both DAS and DVS, high coherence lasers having a narrow linewidth facilitates the phase interferometry from Rayleigh scattered signals, making the measurements sensitive to fiber strain. However, the measurements also exhibit high signal amplitude fluctuations over adjacent fiber locations as a result of high coherence interferometry. Since OTDR relies on the reflected signal amplitude to determine fiber loss, these amplitude fluctuations will make it nearly impossible to measure fiber loss accurately. Moreover, due to the high stable nature of coherent sensing laser source, the amplitude fluctuation signature will be static and cannot be averaged out over time.

As we shall show and describe systems, methods and structures according to aspects of the present disclosure enable conventional OTDR measurements even with high coherence lasers used in DAS/DVS. As noted, by sweeping the wavelength or the frequency of the laser, multiple measurements of distributive Rayleigh scatterings which exhibit different amplitude fluctuations are made. As each measurement obtains uncorrelated fringe profiles from the Rayleigh interferometric process, the measured traces can be averaged across the swept wavelengths/frequencies to remove the amplitude fluctuations and obtain the underlying distributive fiber loss. Advantageously, the wavelengths/frequencies can be done either internally at the laser or by applying modulation signals externally.

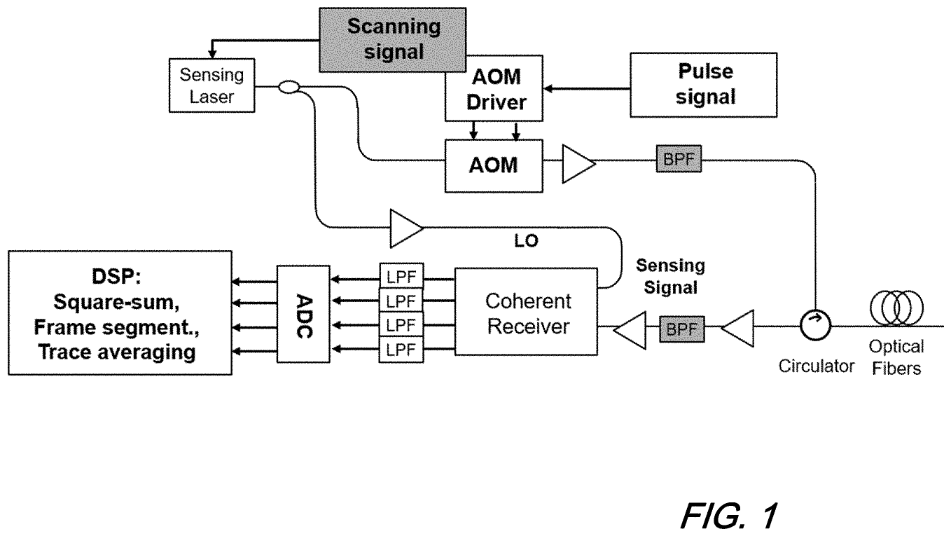

FIG. 1 is a schematic diagram of illustrative coherent DAS configuration with laser wavelength scanning for OTDR measurements according to aspects of the present disclosure.

With reference to that figure, shown therein is an illustrative configuration for OTDR measurements in a typical DAS system using laser wavelength scanning. As shown therein, a scanning signal is applied to a sensing laser that is part of an overall configuration. A more generalized arrangement—without scanning signal(s)—was disclosed in U.S. patent application Ser. No. 16/783,119 of the instant Applicant entitled “Optical Fiber Sensing Systems, Methods, Structures and Application”, filed 5 Feb. 2020, the entire contents of which are incorporated by reference herein as if set forth at length.

Operationally, and for the purpose of the frequency scanning technique according to aspects of the present disclosure, the bandwidth of optical band pass filters (BPF) at transmitters and receivers may have to be widened to accommodate the wavelength scanning range ranges. The operation of the rest of the connected modules/components advantageously remains the same as normal DAS operation.

Note that other configuration variations may be employed. For example, instead of performing frequency/wavelength scanning directly at the sensing laser, it can also be done using an external modulator with single sideband frequency modulation, such as a push-pull MZM or in-phase/quadrature modulator (IQM). Other than the coherent DAS platform shown in the figure, the wavelength/frequency scanning can also be applied to direct-detection based DVS systems to achieve OTDR measurements.

Advantageously, those skilled in the art will understand and appreciate that existing DAS/Digital Signal Processing (DSP) may be modified according to the present disclosure to advantageously perform the OTDR measurements. Operationally—after acquiring a Rayleigh scattered signal from the optical fiber via coherent detection—a square-and-sum operation is performed on four digitized input channels to obtain the optical power profile of the scattered signal across different fiber location. We note that some DAS system may have this square-and-sum function already implemented for the purpose of initial system calibration/optimization.

Subsequently, frame segmentation is performed to align power profiles retrieved from different laser wavelengths in time (or distance after light propagation delay calculation). Next, a trace averaging operation is performed over many power-profile traces, preferably over multiple wavelength/frequency scanning cycles, so that the amplitude fluctuations associated with each Rayleigh power profile can be removed via the averaging process.

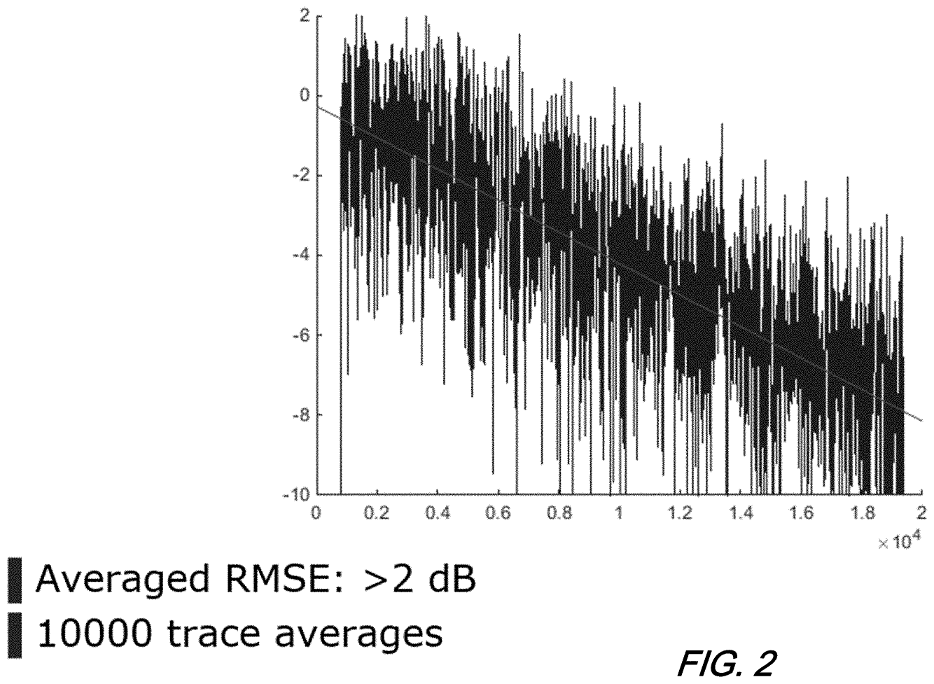

FIG. 2 is a plot of a power profile of a Rayleigh signal in a DAS operation without wavelength frequency scanning. With reference to that figure, we note that the Rayleigh reflection power profile of the received signal in a DAS system is a measurement of the self-interference of the interrogation pulse at each location of the fiber. As shown in FIG. 2, due to the high coherence of the laser source in DAS, the amplitude of the signal at each location exhibits high contrast fringes change due to constructive/destructive interference of the multiple fiber reflections within the optical pulse.

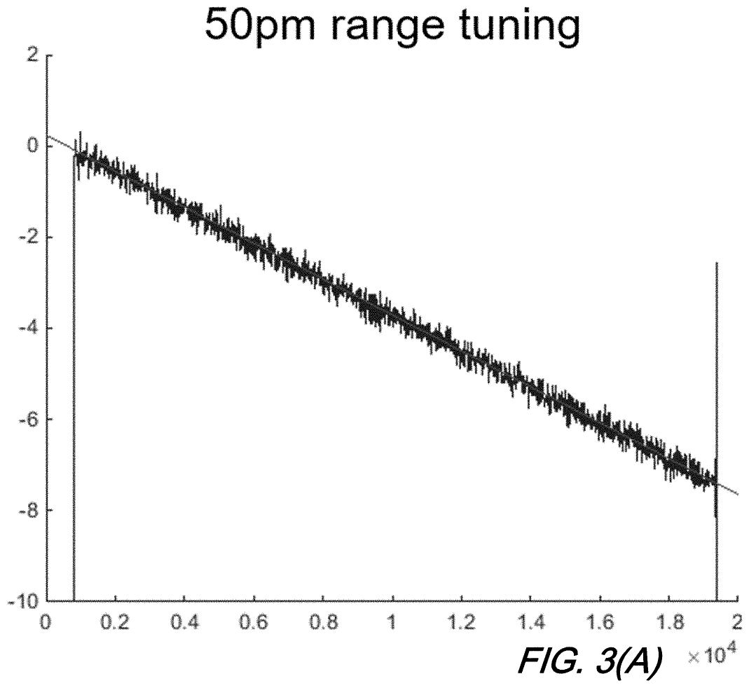

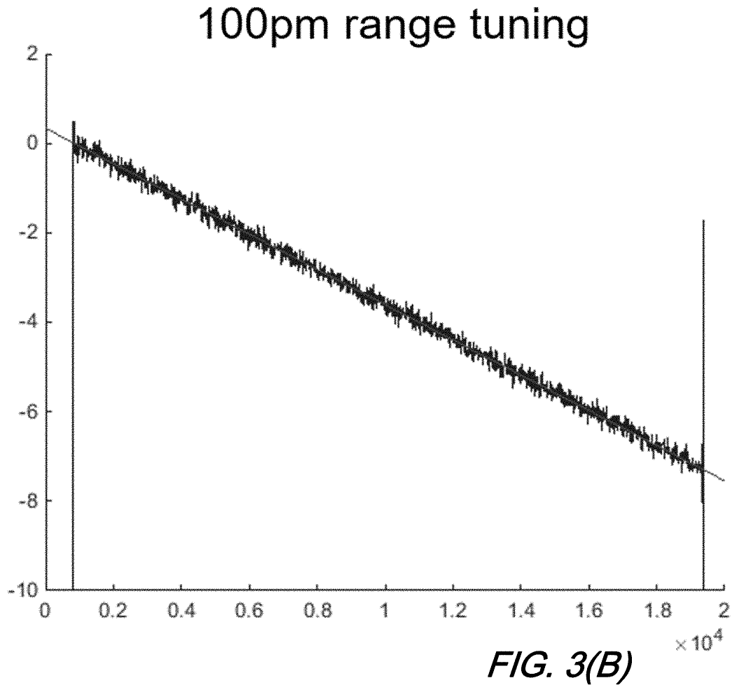

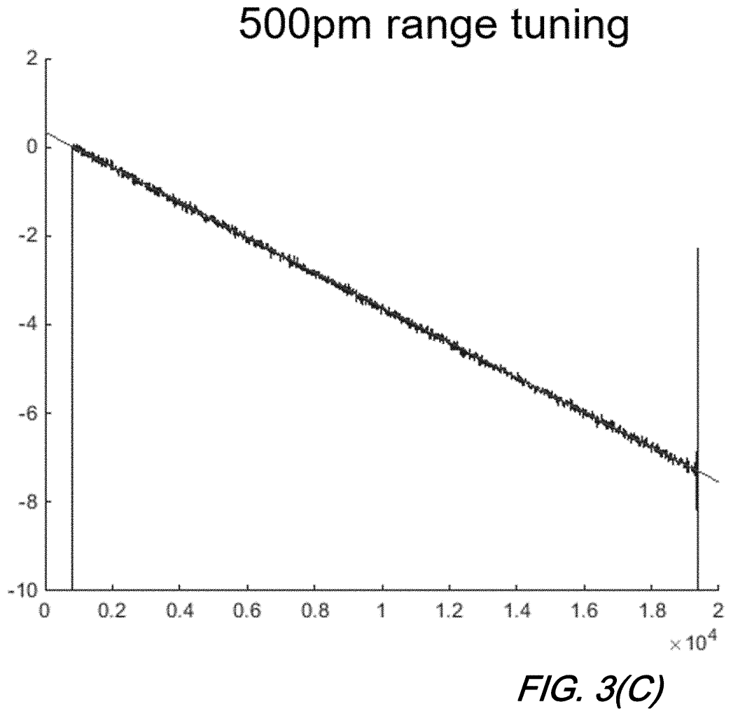

FIG. 3(A), FIG. 3(B), and FIG. 3(C) are plots illustrating power profiles measured with DAS using thermal wavelength tuning in which: FIG. 3(A) shows 50 pm range tuning; FIG. 3(B) shows 100 pm range tuning; and FIG. 3(C) shows 500 pm range tuning, according to aspects of the present disclosure. For these plots, the measurement was performed using a DAS system with ˜100-Hz laser linewidth and acousto-optic modulator (AOM) for pulse generation. A setting of 10-meter spatial resolution and 10,000 times averaging was applied to measure the fiber spool under test with 18.8-km in total length. The RMSE deviation of the measured Rayleigh power fluctuation is greater than 2 dB. With this level of amplitude fluctuation, those skilled in the art will appreciate that such measurement is not suitable to provide fiber loss information as a traditional OTDR.

According to aspects of the present disclosure, OTDR traces can be obtained using a DAS system that changes the laser wavelength/frequency during the power profile measurement. When the same measurement setting as before (10 m resolution, 10,000 averaging), the obtained OTDR traces are plotted in FIG. 3(A), FIG. 3(B), and FIG. 3(C), each at a different wavelength tuning range.

Note that using a built-in thermal tuning function of the high coherence laser, laser wavelength tuning can be achieved with >1-nm tuning range and ˜5-pm/s tuning speed. Other than widening the optical band-pass filter bandwidth to 0.8-nm, as shown previously in FIG. 1, no other modification are necessary to the DAS hardware.

With reference to FIG. 3(A), FIG. 3(B), and FIG. 3(C), it may be observed that three different measurements were performed, using different thermal tuning range over 50 μm, 100 μm, and 500 pm, respectively. As compared to the plot shown in FIG. 2, the optical power profiles exhibit much smaller fluctuations in amplitude. The RMSE deviation decreases as the tuning range increases, reaching 0.17 dB, 0.12 dB, and 0.06 dB respectively. The results clearly demonstrate the feasibility of OTDR function implementation using wavelength tuning, with capability to detect fiber loss anomalies down to 0.1-dB scale. All measurements, including 10,000 times averaging, were done in about 90 seconds, as tuning speed are typically slow for thermally tuned laser.

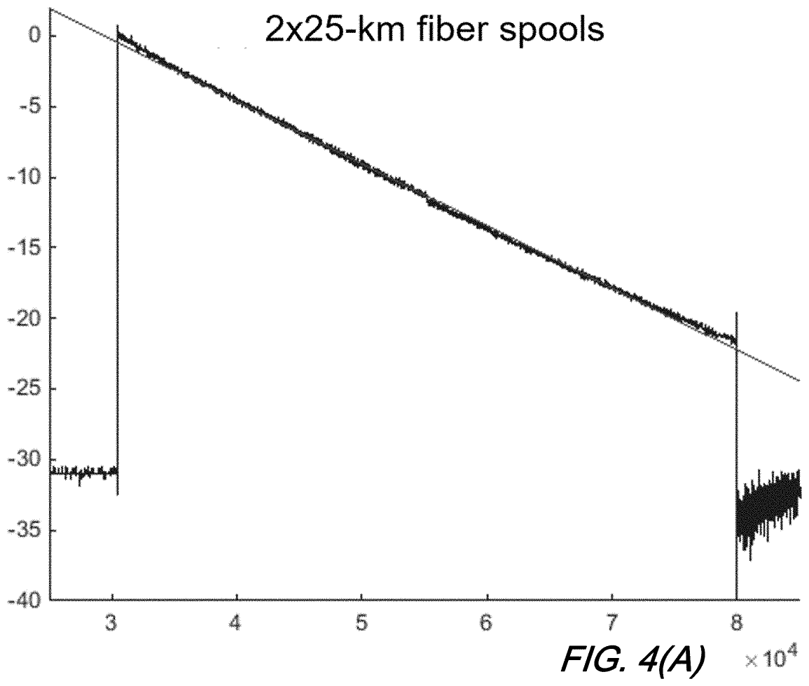

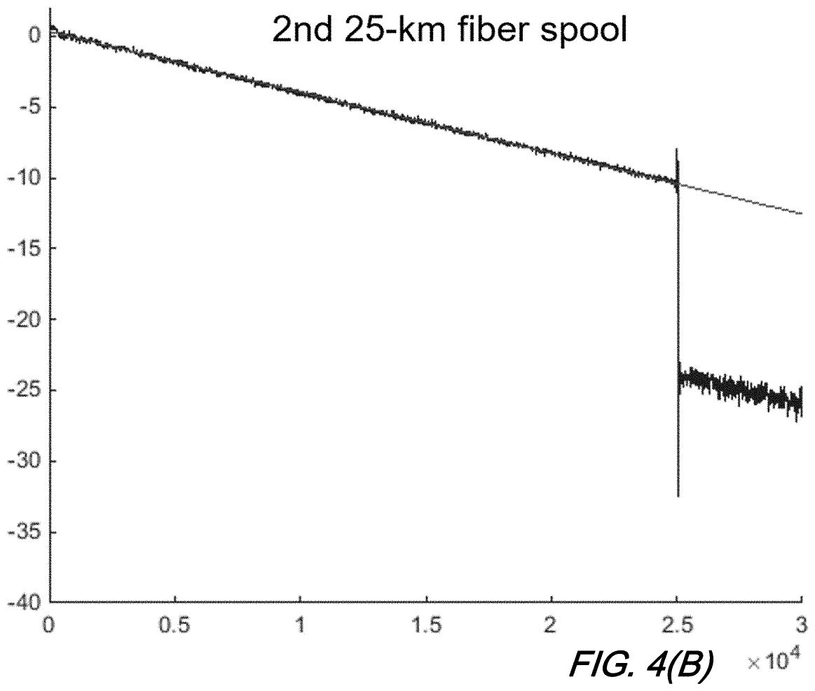

Other than thermal tuning, laser wavelengths can also be tuned via a modulation signal through piezo-electric effect. FIG. 4(A) and FIG. 4(B) are plots illustrating power profiles measured with DAS using piezo-electric wavelength tuning in which: FIG. 4(A) shows a first 2×25-km fiber spool; and FIG. 4(B) shows a second 2×25 km fiber spool, according to aspects of the present disclosure. In these figures, we plotted the power profiles measured using the piezo-electric modulations scheme. An electric ramp signal with ˜10-Hz repetition-rate is used to drive the high-coherence laser with piezo-electrical modulation port. Within each ramp cycle, 100 optical pulses are generated to make power profile measurements at different laser frequencies. Using the same setting, 10-m resolution and 10,000× averaging, we can obtain OTDR traces on a 50-km long test fiber link, as shown in FIG. 4(A).

We note that the frequency scanning rage achieved via piezo-electric modulation is ˜120 pm. Due to the faster modulation slew rate compared to thermal tuning, the entire measurement(s) can be completed within 10 seconds. One can clearly observe the fiber connection point between two 25-km fiber spools, with roughly 30-dB dynamic range to the system noise level in the measurement. Note that a greater dynamic range can be achieved if gain/ADC range can be adjusted. When focusing on the second fiber spool using different scope input gain setting, as shown in FIG. 4(B), we observe a larger margin at the end of the fiber spool (˜15-dB), giving a total dynamic range of ˜35-dB. The RMSE deviations of the measured power profile is ˜0.11-dB, which is consistent with the previous thermal tuning results under similar tuning range.

We note that even though internal wavelength/frequency tuning at the laser source is likely the easiest way for implementation of systems, methods, and structures according to the present disclosure, external frequency modulation using optical modulator, such as push-pull MZM or in-phase/quadrature modulator (IQM), can also be used to achieve frequency scanning. In this case, a scanning RF frequency source will be used to drive the modulators to create single-sideband frequency modulated signals. The rest of the interrogation and detection scheme to obtain the power profile will be similar to that discussed previously.

At this point, while we have presented this disclosure using some specific examples, those skilled in the art will recognize that our teachings are not so limited. Accordingly, this disclosure should only be limited by the scope of the claims attached hereto.

1. A distributed optical fiber sensing (DOFS) system configuration for performing optical time domain reflectometry (OTDR) measurements, the DOFS system comprising:
a length of optical fiber;
an optical interrogator unit that generates optical pulses from laser light, introduces them into the optical fiber and receives Rayleigh reflected signals from the fiber; and
a receiver unit configured to extract OTDR information from the Rayleigh reflected signals;
wherein the laser light is scanned over wavelength and/or frequency.

2. The DOFS system configuration for performing OTDR measurements of claim 1 wherein the receiver unit is configured to average over multiple measurements the OTDR information.

3. The DOFS system configuration for performing OTDR measurements of claim 2 wherein a laser that produces the laser light is scanned over a scanning range of at least 10-GHz.

4. The DOFS system configuration for performing OTDR measurements of claim 3 further comprising a scanning signal generator that drives the laser scanning.

5. The DOFS system configuration for performing OTDR measurements of claim 3 further comprising a modulator with single sideband frequency modulation that is configured to scan the laser light over wavelength and/or frequency.

6. The DOFS system configuration for performing OTDR measurements of claim 5 wherein the modulator comprises a push-pull Mach-Zehnder Modulator (MZM) or in-phase/quadrature modulator (IQM).
